(19) United States
(12) Patent Application Publication
(10) Pub. No.: US 2003/0069833 A1
(43) Pub. Date: Apr. 10, 2003

(54) Muniflow-cash management & investment services for municipalities, school districts and authorities, and other entities

(76) Inventor: Joseph R. Rulison, Rochester, NY (US)

Correspondence Address: Joseph R. Rulison, 2300 Chase Square, Rochester, NY, 14604, US

(21) Appl. No.: 09/972,145

(22) Filed: Oct. 5, 2001

(51) Int. Cl. G06F 17/60

(52) U.S. Cl. 705/37; 705/38

(57) ABSTRACT

A process by which a Preliminary Analysis (10) uses Enhanced Cash Flow Statement (12) and Account Balance Analysis (14) to provide a historic basis and knowledge of cash receipts and cash needs for expenditures. Analysis Update (18) constantly monitors the receipt and disbursements of cash in order to prepare an update-to-day Investment Proposal (24). Investment Preparation (22) involves documentation (20) and takes the aforementioned analyses and provides a means by which funds are competitively bid through the Bidding Process (28) to a variety of financial institutions; finding the best rate available on any given day. The Bidding Process (28) is based on Investment Proposal (24) written to match cash flows shown in Enhanced Cash Flow Statement (12) and Account Balance Analysis (14). Weekly Cash Balances (26) provides information to this process to determine if cash levels are such to allow for further investments. Continuous Monitoring (30) of all aspects of an entities cash flow is taken from the entities own accounting documents as well as from bank account statements shedding light on activity changes that may impact future cash flows and thus Investment Proposal (24). Client Binders (32) are used for constant Reporting (34) so that the entity knows at all times the status of its cash flow and investments. Annual Health Check (36) is used to ensure constant compliance with all applicable laws, policies and regulations governing investments within each entity.

### CROSS REFERENCES TO RELATED APPLICATIONS

Not Applicable

### BACKGROUND

1. Field of Invention

This invention relates to municipal cash management, specifically designed to provide better information in order to maximize invested dollars and increase interest earnings.

2. Description of Prior Art

As noted in FIG. 23, municipalities have information provided to them on the revenues and expenditures of thier funds. However, this document alone is not sufficient to soley maximize invested dollars and increase interest earnings. It has been difficult to maximize the interest income on a government's available cash heretofore without the process and tools of this invention—Muniflow®.

FIG. 23 is a prior art tool that has typically been used to gauge a municipality's cash flow. This invention has enhanced this cash flow statement by adding “note boxes” designed to allow the user to find specific dates of large cash payouts. Other tools have also been added that help the user to invest cash as soon as possible and keep it invested as long as possible as well as tools to monitor the percent of all available dollars that are invested. The goal is to increase the percent of total avialable dollars invested, maximizing the use of avialable funds and increasing interest earnings.

Both the Cash Budgeting Model and the Cash Flow Statement used by governments prior to this invention provided governments with the internal perspective of their cash position. However, actual available cash depends on how the financial institutions who hold the money see the in- and out-flow of money. This flow is generally different than the government perspective for one main reason. In accounting, governments consider money as expended or received on the day the checks or bills (tax notices) are cut or approved. However, from the bank perspective, money is not ever spent or received until the check is cashed or actually deposited. Based on the type of expenditures or reciepts, the distance to the address where checks are mailed, and the typical amount of time the recipient holds a check all add to Float—the time difference from when the check is actually written to when the cash is actually taken from or credited to the government account.

Investment services prior to this invention were simple. The government would determine the amount of money to be invested and how long. Those providing investment services to governments would take that money and invest it as appropriate based on the terms provided from the government. The additional tools described in this process allow the investment advisor to play a larger role in investment decisions.

One role is to constantly monitor the actual cash position. As a cash manager (knowing when cash is received, when it is needed for expenditures, and how long it is available for investments) allows the investment advisor to help determine the actual amount of cash available for investments and how long. The second major role to play is that of market expert. Monitoring rates in the market and the various types of investment vehicles available allow the investment advisor to make specific recommendations as to the term and type of investments.

For example, a government may say that they have $5,000,000 to invest for 45 days. As an advisor using this invention, we would be able to determine if the actual number is $5,500,000 (10% more) and recommend that current rates are better at very short terms (i.e. 11 days) so to stay short and reinvest until the 45 day mark. This then maximizes the amount invested as well as the rate at which the money is invested.

### SUMMARY INCLUDING OBJECTS AND ADVANTAGES

A process of increasing the dollars invested leading to increased interest earnings. Each part of this process is important to the determination of investable dollars or the maximizing of rates available on those dollars invested. Historic analysis of cash flow and bank statements allows for projection of future cash levels, cash needs and cash receipts. Continuous monitoring and updating of historic analysis provides current information on availalbe dollars for investing. Market projections provide the means to overlay what they market has and will have available with the cash needs of the entity. A competitive bidding process provides a means to determine the highest rate avialable that day for the investment vehicle chosen. Strict use of documentation provides easy audit trail for interested parties.

### OBJECTS AND ADVANTAGES

Accordingly, several objects and advantages of my invention are to maximized the amount of dollars invested thereby increasing interest earnings of a municipality. Further objects and advantages are a better cash flow projection, better understanding of market conditions, timing and term of borrowing, potential to enhance credit rating by showing due diligence to those organizations who provide bond ratings to municipalities, better banking services, more efficient internal office processes and ease of audits due to provided reports and filing system.

Still further objects and advantages will become apparent from a consideration of the ensuing description and accompanying drawings.

### BRIEF DESCRIPTION OF THE DRAWINGS

FIG. 1 shows the overall Muniflow Process

FIG. 2 is an Enhanced Cash Flow Statement showing the various parts of a municipalities cash flow

FIG. 3 shows the data and graph of an Account Balance analysis

FIG. 4 is a Summary sheet of information found during the Preliminary Analysis step

FIG. 5 shows the list of materials needed to provide a preliminary and ongoing analysis of a municipalities cash flow

FIG. 6 is a sample letter municipalities send to financial institutions providing authorization for Muniflow to gather information on behalf of the municipality

FIG. 7 is a sample fax bid sheet that is faxed to financial institutions inviting them to bid on a municipality's funds

FIG. 8 is a sample summary sheet used by Muniflow to provide a summary of bid rates provided by various financial institutions

FIG. 9 is a sample Weekly Cash Balance sheet that reports to a municipality the balance on the day balances where checked through this invention

FIG. 10 is a sample of the meeting minutes that are kept each time a Muniflow employee meets with a municipality contracted with the inventor

FIG. 11 shows the General Bidding Process from the perspective of the client

FIG. 12 shows in graphical form the muniflow process, involved players and potential investment vehicles

FIG. 13 is a sample Investment Proposal providing investment recommendations that meet a municipalities cash flow as well as takes advantage of the best investment vehicles and terms offered in the market under current conditions

FIG. 14 shows in graphical form some investment vehicles and thier advantages over time

FIG. 15 is a graphical form of the lenghth (term) of an investment and the potential advantages under sample market conditions

FIG. 16 is a sample listing of account balances with graphs to show historic patterns that can be used to find investment vehicles that match the bank account pattern

FIG. 17 is a sample Current Portfolio report provide monthly to municipalities

FIG. 18 is a sample Current Maturity Schedule report provided monthly to municipalities

FIG. 19 is a sample quarterly or annual report

FIG. 20 is a Monthly interest rate memo discussing interest rate outlook and general investment guidelines based on that outlook

FIG. 21 is an Investment Ratio Report used to monitor the progress of increasing the amount of avialable cash that is invested

FIG. 22 is a Sheet used to report what is to be invested on a specific date, by which municipality, how long, what type of fund and what bank currently hold the money

FIG. 23 is a Prior art depiction of a typical cash flow statement used by finance officers of municipalities

FIG. 24 is a Sample Investment Policy and Procedures addopted by municipal legislatured and used to guide investments in the Muniflow process

### REFERENCE NUMERALS

10 Preliminary Analysis

12 Enhanced Cash Flow Statement

14 Account Balance Analysis

16 Summary Sheet

18 Analysis Update

20 documentation

22 Investment Preparation

24 Investment Proposal

26 Weekly Cash Balances

28 Bidding Process

30 Continuous Monitoring

32 Client Binders

34 Reporting

36 Annual Health Check

### SUMMARY INCLUDING OBJECTS AND ADVANTAGES

A process of increasing the dollars invested leading to increased interest earnings. Each part of this process is important to the determination of investable dollars or the maximizing of rates available on those dollars invested. Historic analysis of cash flow and bank statements allows for projection of future cash levels, cash needs and cash receipts. Continuous monitoring and updating of historic analysis provides current information on availalbe dollars for investing. Market projections provide the means to overlay what they market has and will have available with the cash needs of the entity. A competitive bidding process provides a means to determine the highest rate avialable that day for the investment vehicle chosen. Strict use of documentation provides easy audit trail for interested parties.

### OBJECTS AND ADVANTAGES

Accordingly, several objects and advantages of my invention are to maximized the amount of dollars invested thereby increasing interest earnings of a municipality.

Further objects and advantages are a better cash flow projection, better understanding of market conditions, timing and term of borrowing, potential to enhance credit rating by showing due diligence to those organizations who provide bond ratings to municipalities, better banking services, more efficient internal office processes and ease of audits due to provided reports and filing system.

Still further objects and advantages will become apparent from a consideration of the ensuing description and accompanying drawings.

### Preferred Embodiment—Description

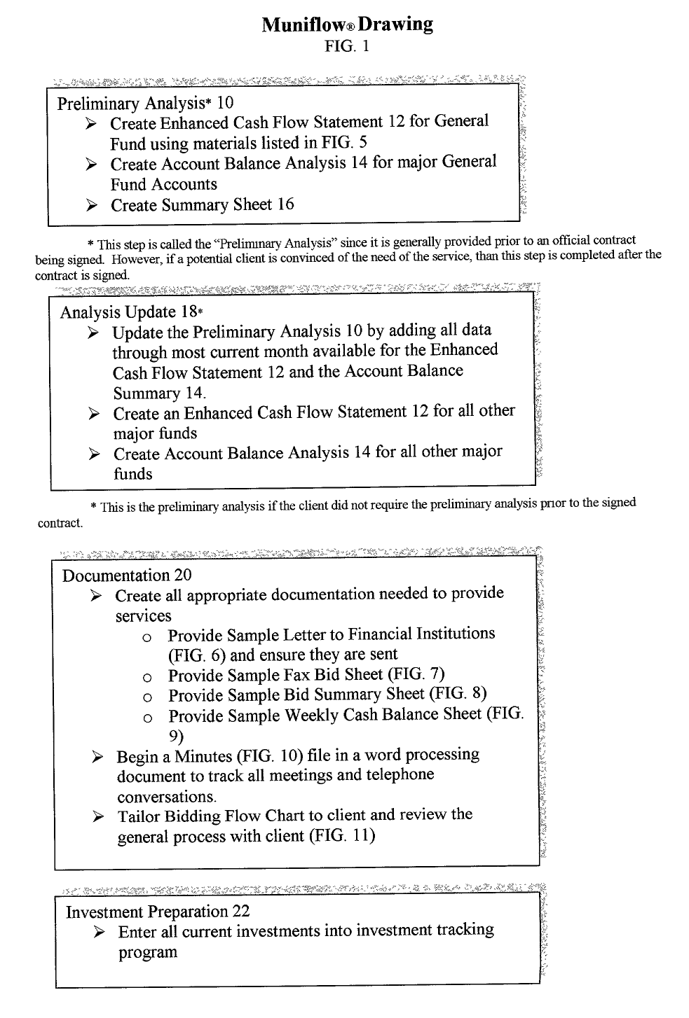

Referring now to FIG.1, there is shown the Muniflow process with each individual step listed. The main steps of this process are:

Preliminary Analysis 10, including:

Create Enhanced Cash Flow Statement 12 for the General Fund (see FIG. 2) which determines historic levels of cash during each month.

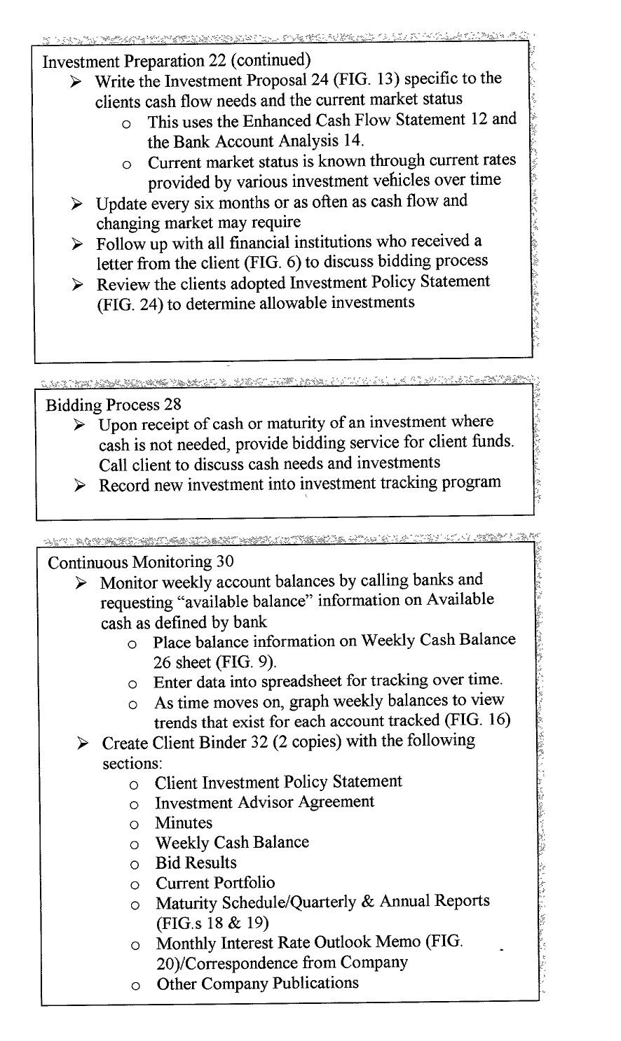

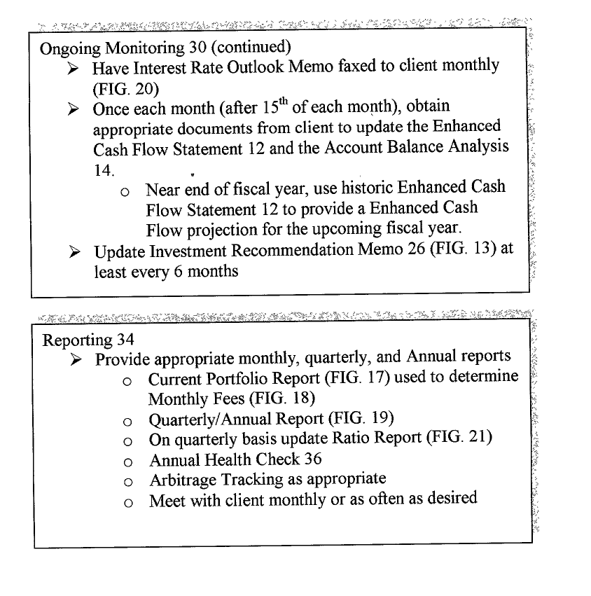

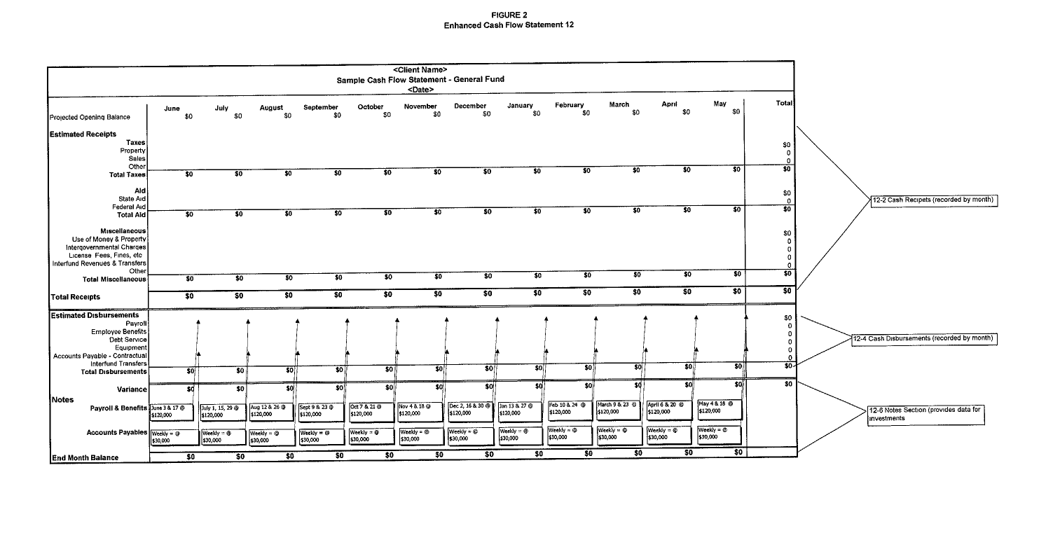

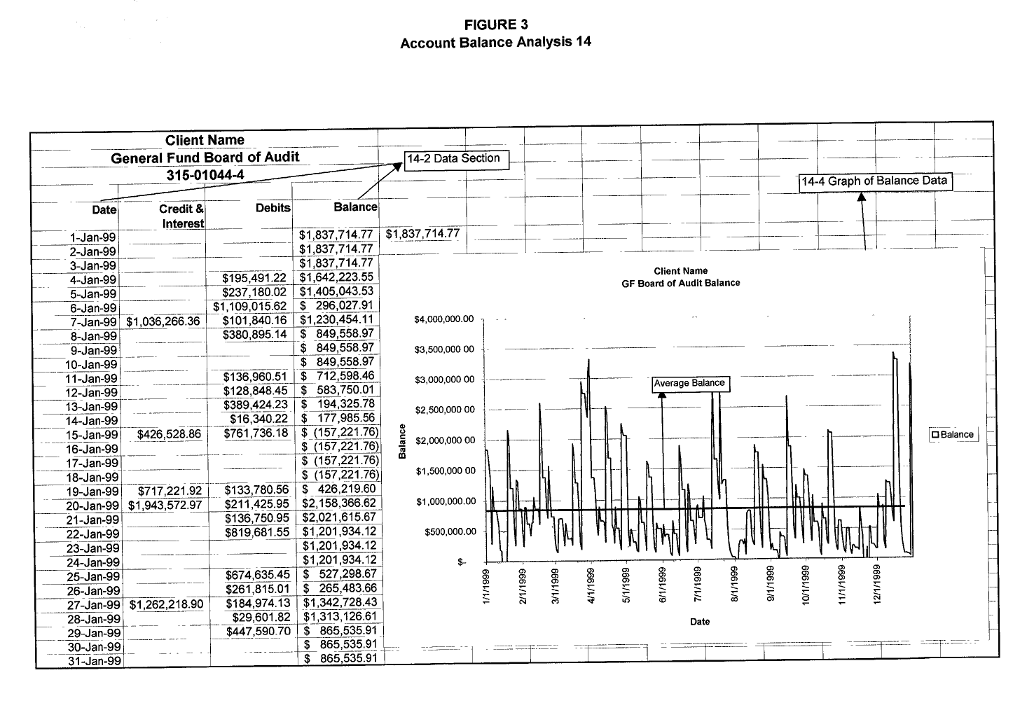

Create Account Balance Analysis 14 for General Fund Bank Accounts (see FIG. 3) which determind the historic level of cash as per bank accounts.

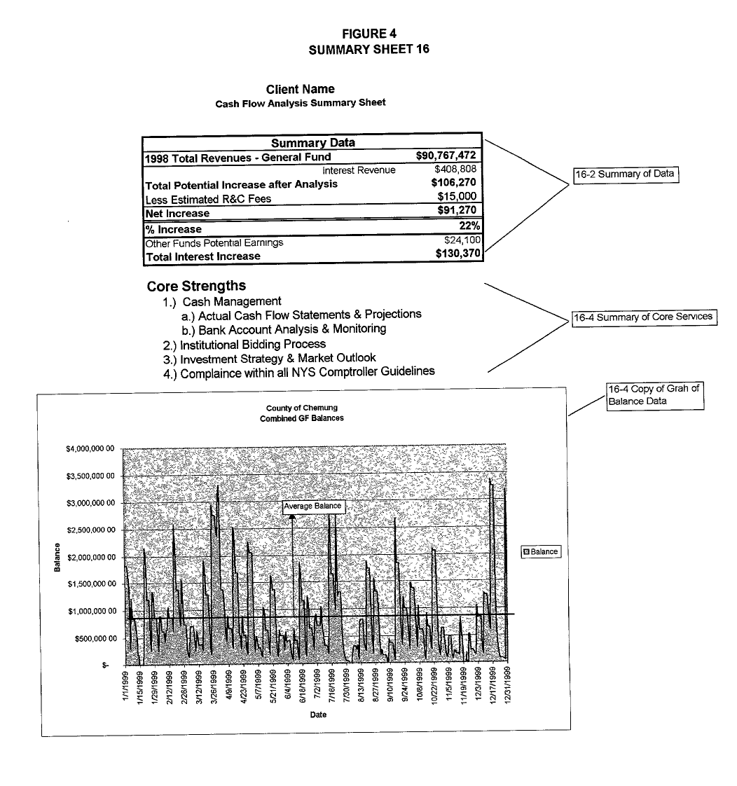

Create Summary Sheet 16 (see FIG. 4) describing findings of the Preliminary Analysis 10.

Analysis Update 18 after a signed agreement has been entered into, including:

Update Enhanced Cash Flow Statement 12 to most current month for General Fund.

Update Account Balance Analysis 14 to most current month for General Fund Bank Accounts.

Create an Enhanced Cash Flow Statement 12 for all other major funds to find historic cash levels of all funds.

Create Account Balance Analysis 14 for all other major fund bank accounts.

Prepare all Documentation 20, including:

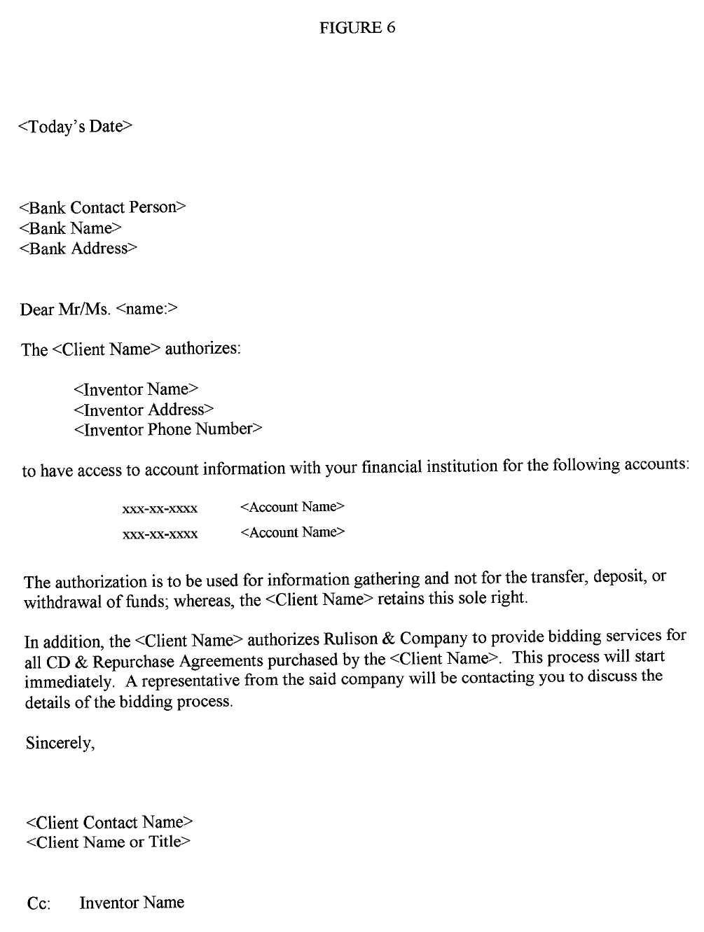

Letter to Financial Institutions (see FIG. 6)

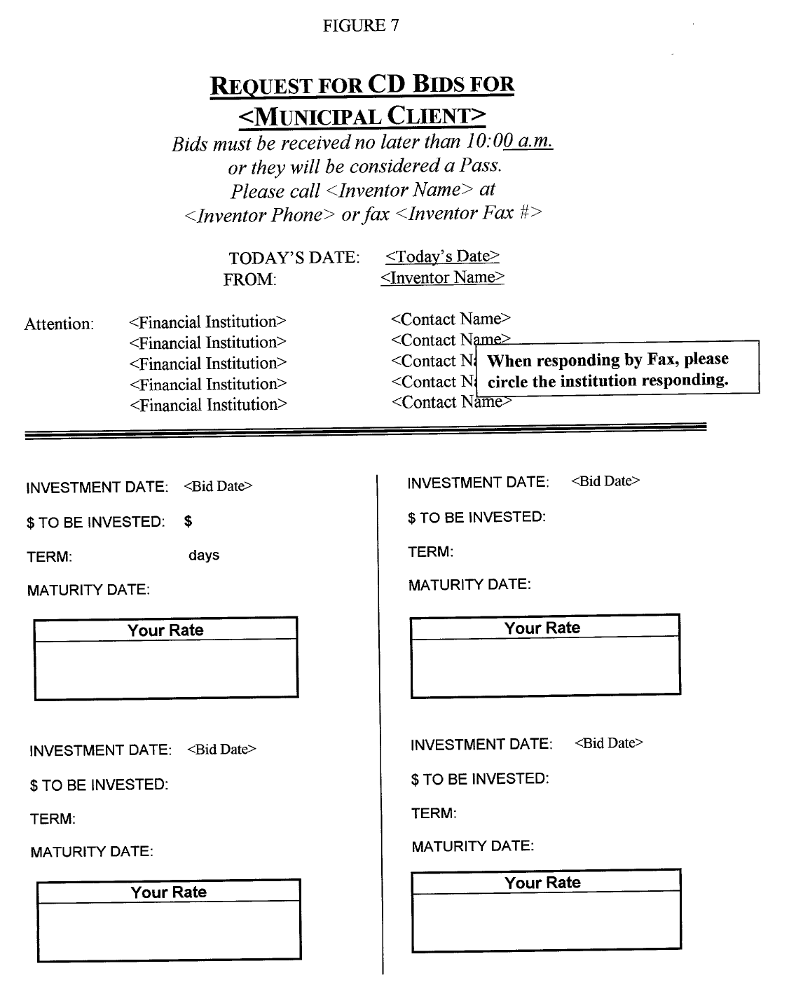

Bid Sheet for Client (see FIG. 7)

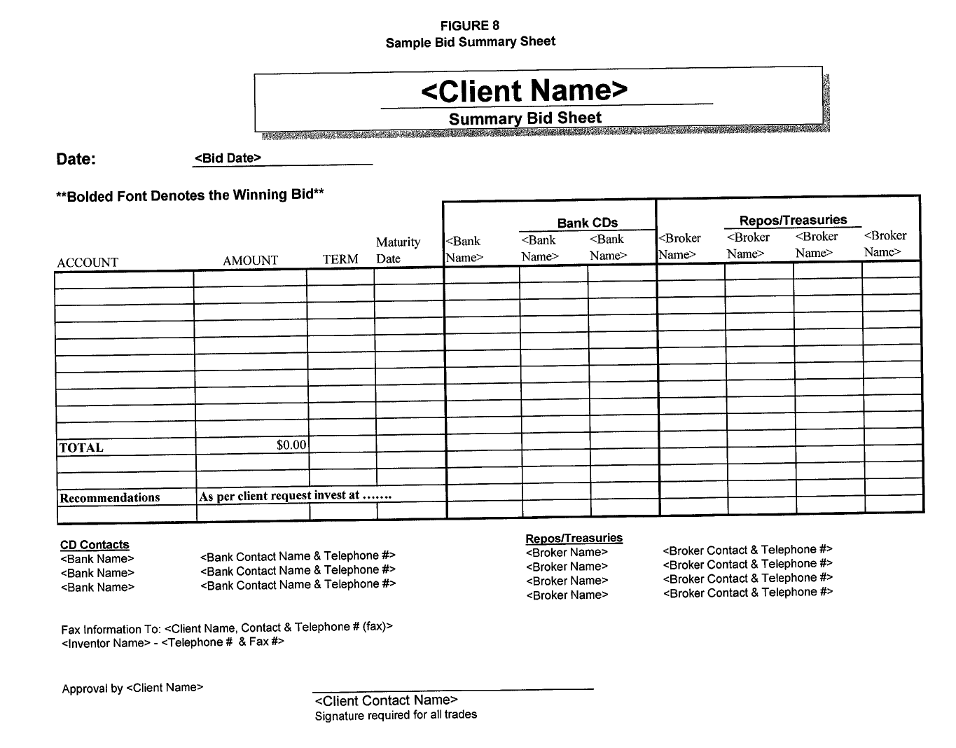

Bid Summary Sheet (see FIG. 8)

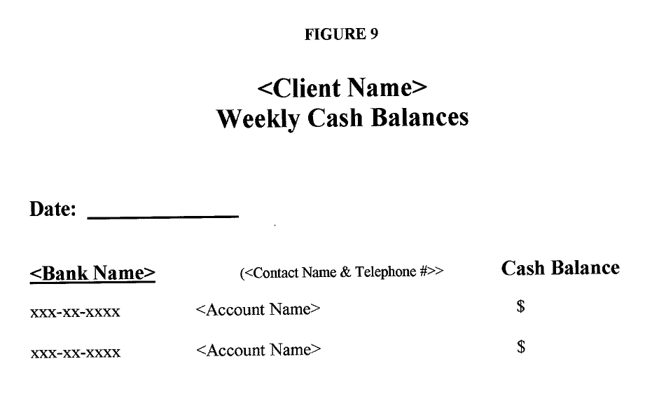

Weekly Cash Balance 26 Sheet (FIG. 9)

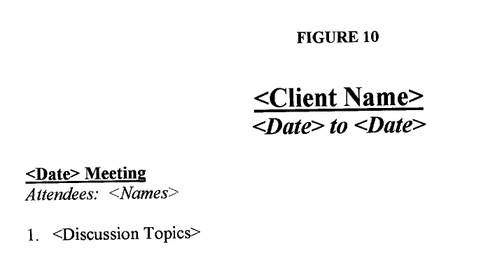

Minutes Template (see FIG. 10)

Bidding Flow Chart (see FIG. 1 1)

Investment Preparation 22, including:

Enter all data about current outstanding investments into an investment-tracking program.

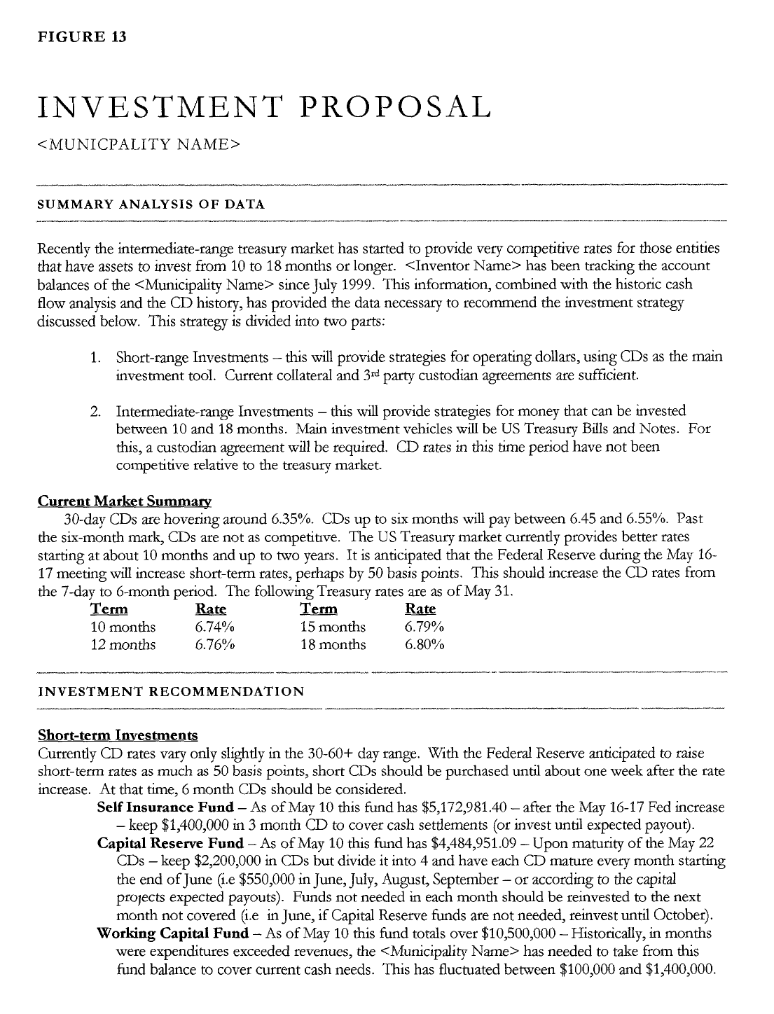

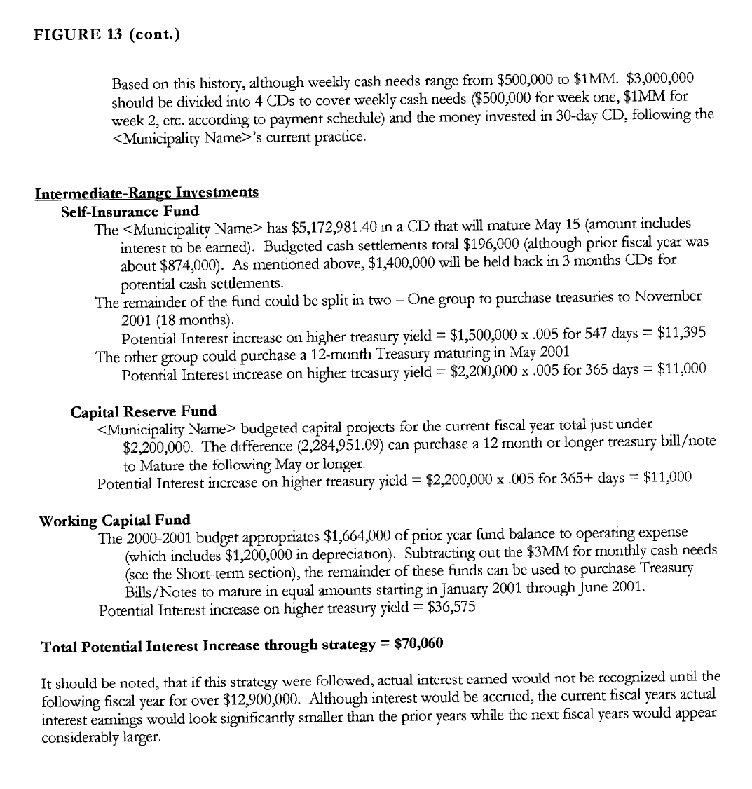

Write Investment Proposal 24 (see FIG.13) specific to client cash needs as determined by the Preliminary Analysis 10 and Analysis Update 18.

Follow up with all financial institutions that received a Letter to Financial Institutions (see FIG. 6).

Bidding Process 28, including:

Call client to discuss upcoming investments (because money matured and should be reinvested or new cash has been received that can be invested).

Record new investments into investment tracking program.

Monitor Weekly Cash Balances 26 (see FIG. 9) by calling banks and requesting “available balances” on all accounts respective to the client banks.

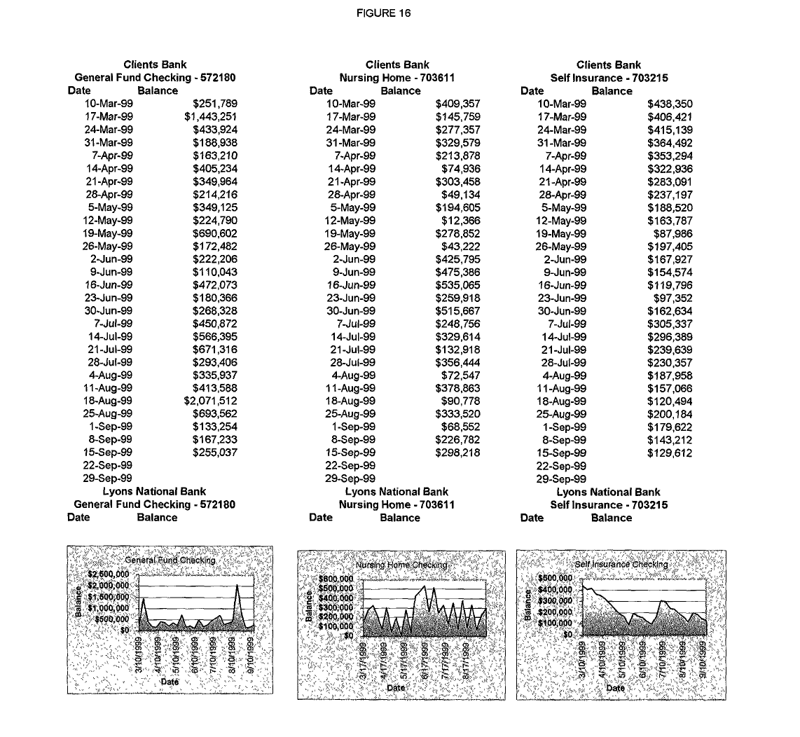

Enter Weekly Cash Balances 26 data into spreadsheet for tracking (see FIG. 16).

Continuous Monitoring 30, including:

Weekly Cash Balance 26

Create 2 Client Binders 32 (one for client and one for company) with the following sections:

Client Investment Policy Statement

Investment Advisor Agreement (signed)

Minutes (see FIG. 10)

Weekly Cash Balance 26 (see FIG. 9)

Bid Summary Sheets (see FIG. 8)

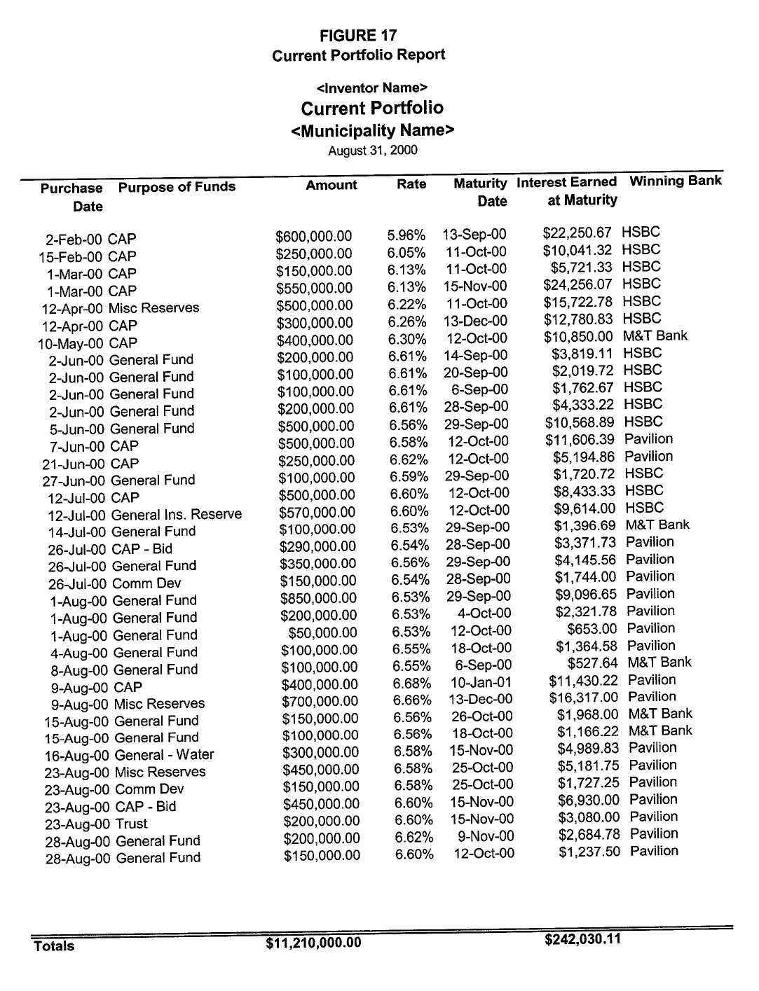

Current Portfolio Report (see FIG. 17)

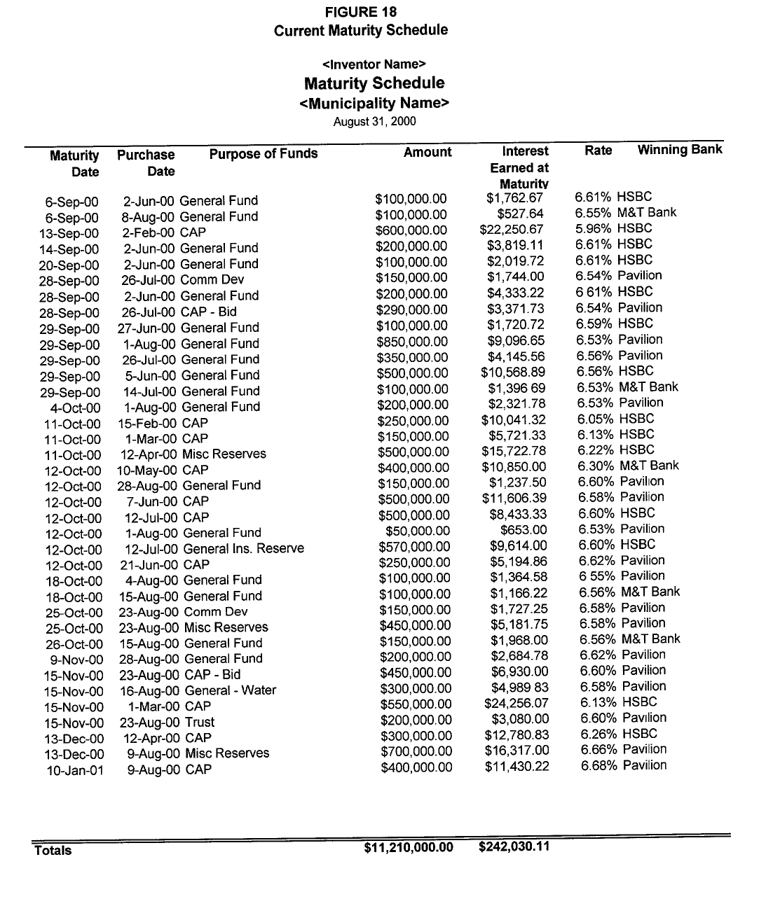

Maturity Schedule/Quarterly & Annual Reports (see FIG. 18 & 19)

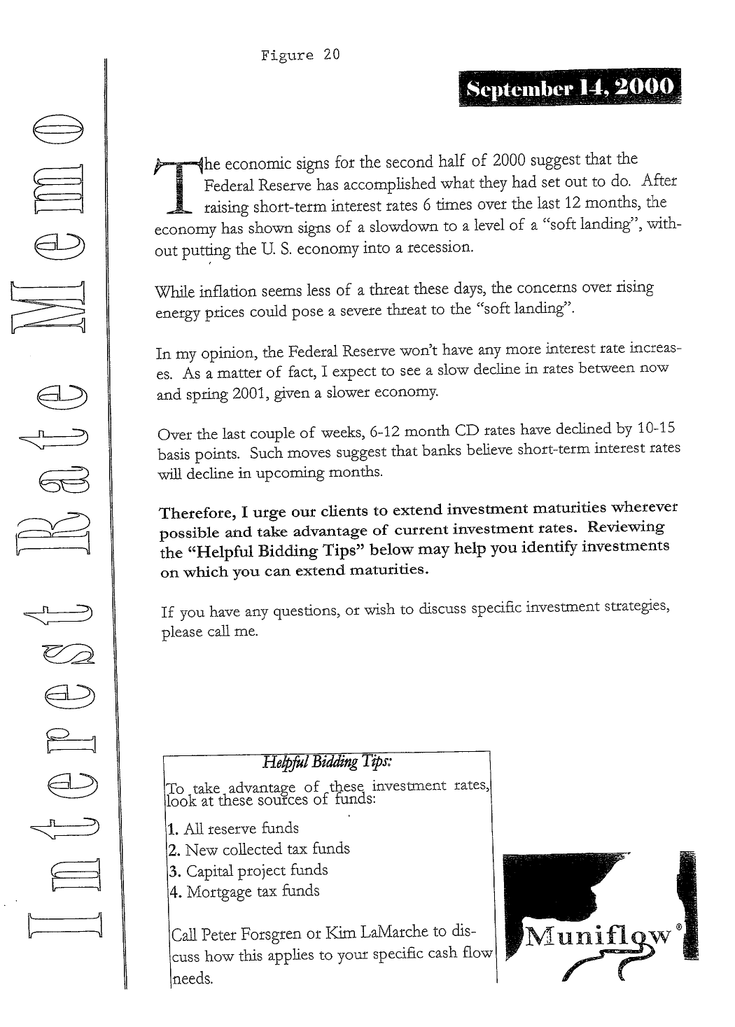

Monthly Interest Rate Memo/Other Correspondence (see FIG. 20)

Other Company Publications

Fax Monthly Interest Rate Memo (see FIG. 20). This can be more frequent than monthly if the market changes dictate.

After 15th of each month, update Enhanced Cash Flow Statement 12 and Account Balance Analysis 14 for all funds and banks accounts

Update Investment Proposal 24 (see FIG. 13) at least every 6 months or more frequently as client's needs change or market outlook changes.

Reporting 34—Provide the following reports as described below:

Current Portfolio Report (see FIG. 17) on a monthly basis

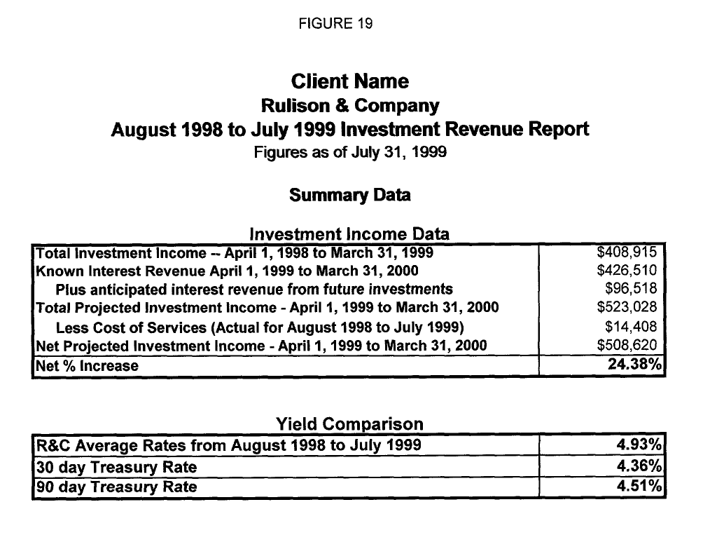

Quarterly/Annual Report (see FIG. 19) as needed based on start date of contract

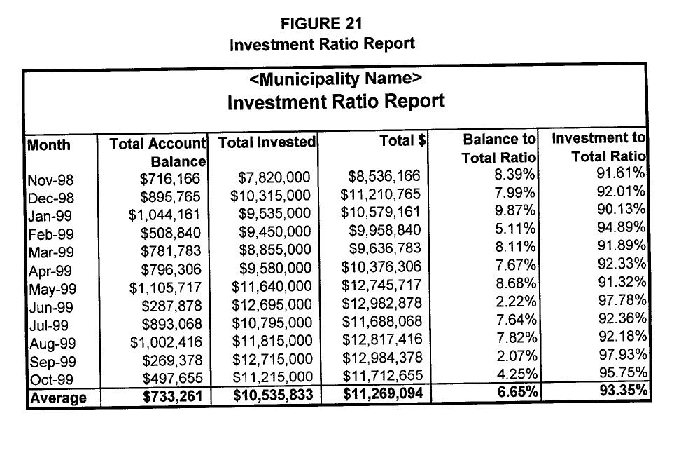

Ratio Report (FIG. 21)—quarterly or as needed

Meet monthly or as frequently as client desires

Provide Annual Health Check 36 by reveiwing all pertinent legal documents and ensuring compliance as per state laws

### Preferred Embodiment—Operation

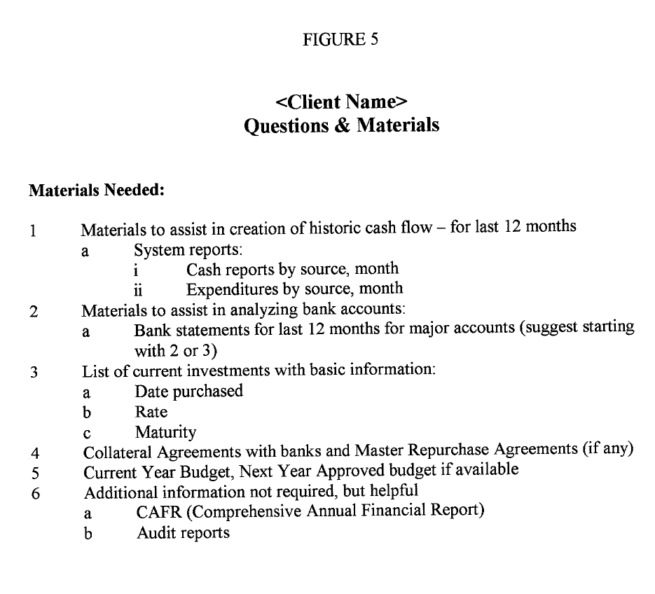

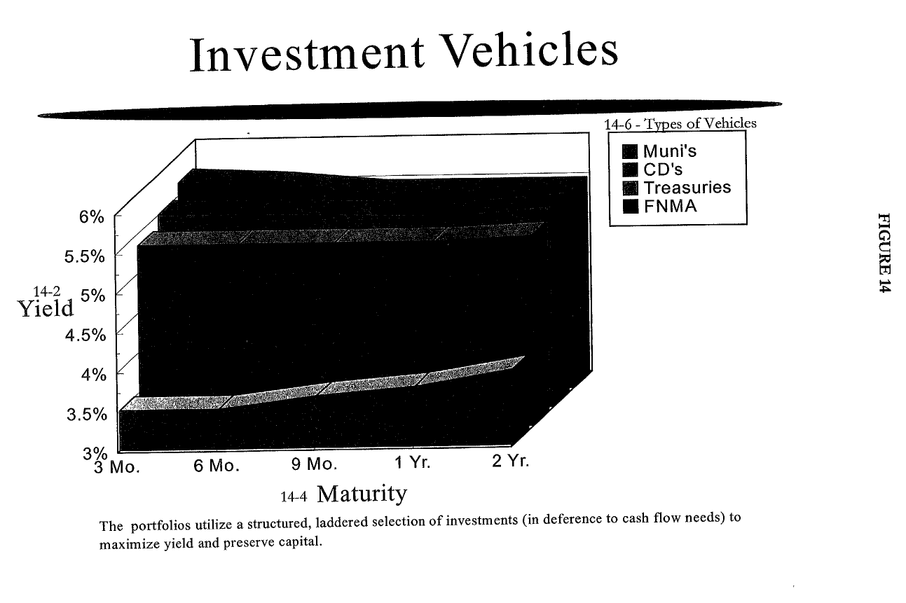

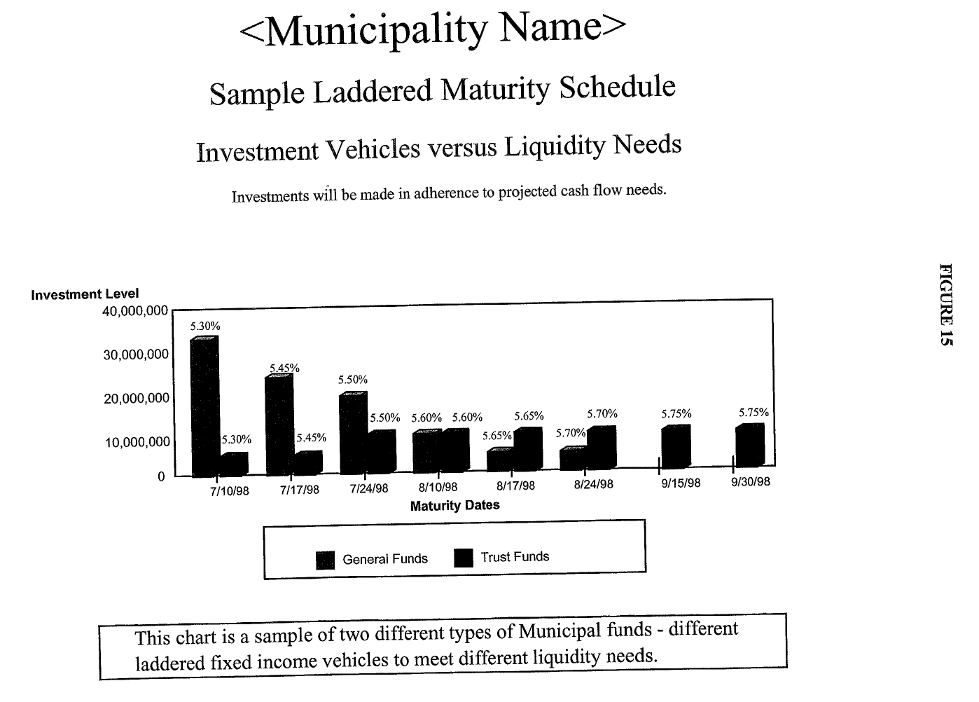

FIG. 1 represents the overall Muniflow process. Each step in this figure will be discussed in more detail below with reference to FIGS. 2 to 24. Muniflow process starts with the Preliminary Analysis 10 to determine the degree of interest increase that may be derived through the invention. Preliminary Analysis 10 is done through data entry of materials listed in FIG. 5 into the templates as shown in FIGS. 2 and 3 creating Enhanced Cash Flow Statement 12 for the general fund and Account Balance Analysis 14 also for the general fund. The results of this data are summarized in FIG. 4.

Upon approval to proceed with our work, the Analysis Update 18 is completed by repeating and updating to the most current month the steps under Preliminary Analysis 10 for all fund types. This involves creating Enhanced Cash Flow Statement 12 and Account Balance Analysis 14 for each fund and bringing them up to date to the most current month for which data is available.

To fully provide this service, a complete set of Documentation 20 must be created. Each individual document of this step is shown in FIGS. 6 to 11. Creating these documents is simple. All parts in yellow need to be replaced with appropriate information pertaining to the client for n whom Muniflow is being provided. Minutes 24 (FIG. 10) for all discussions, whether on telephone or in person, that pertain to the client. Bidding Flow Chart 24 is tailored so that the municipality understands the process of daily bidding.

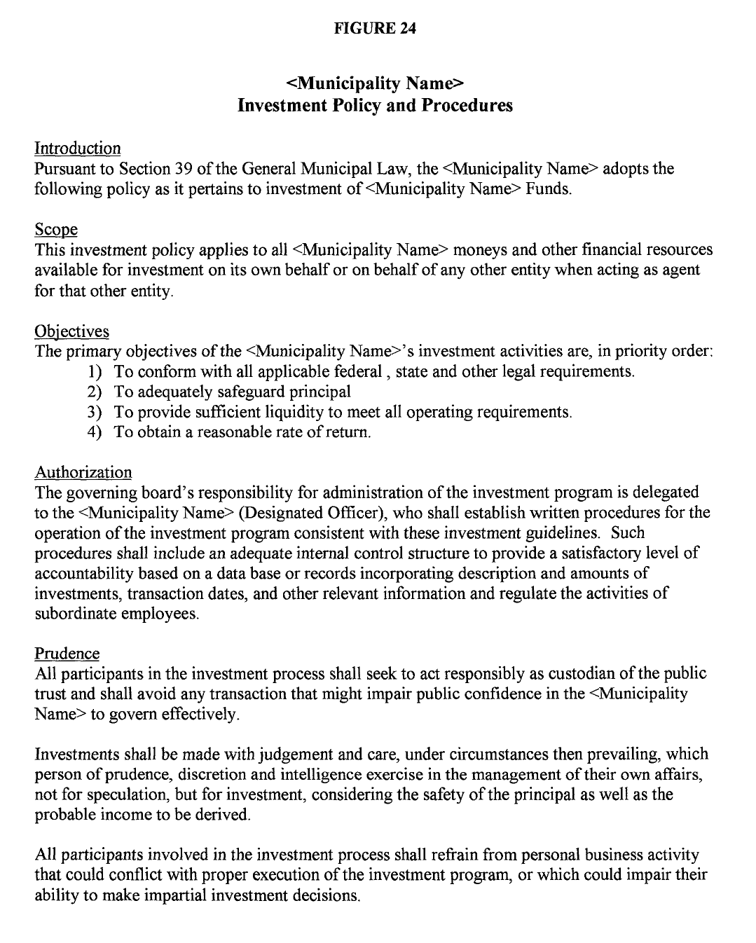

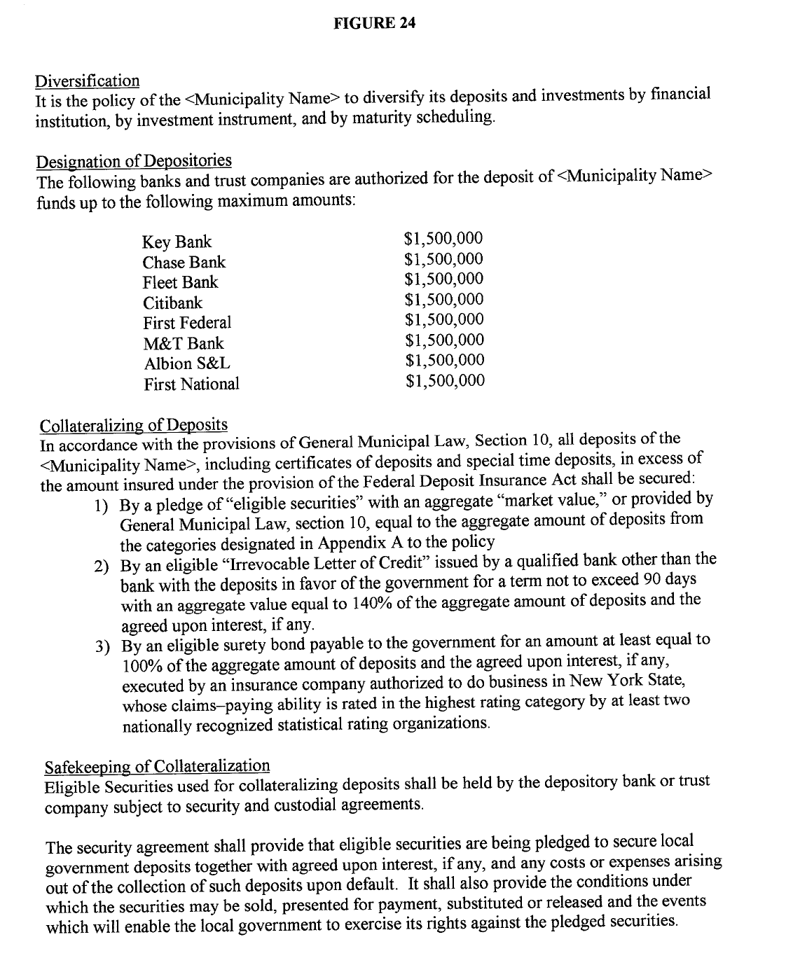

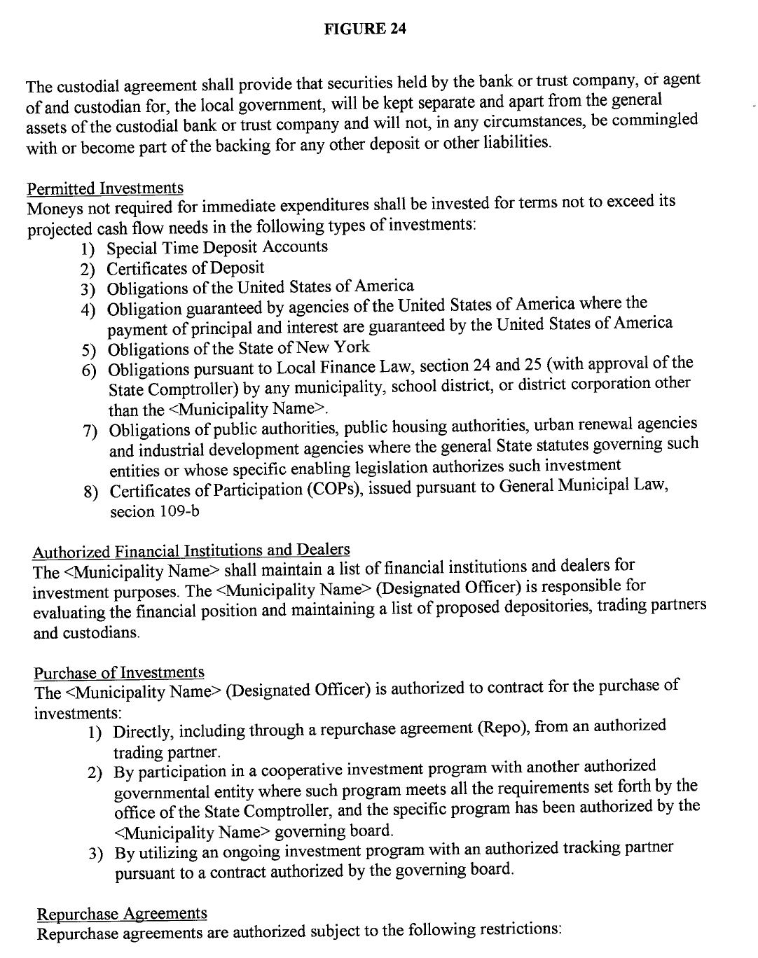

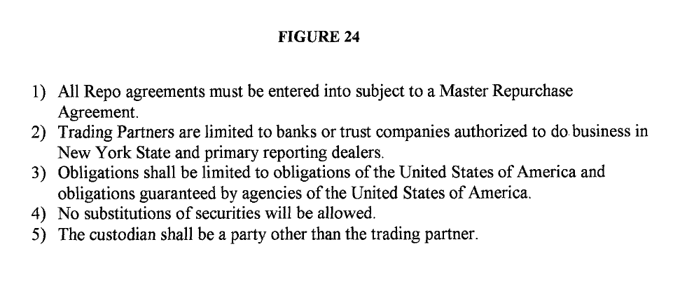

Investment Preparation 22 gears ups for bidding municipal money to a variety of banks by writing Investment Recommendation Memo 24 (FIG. 13). Information for this Memo 24 is taken from information in the Enhanced Cash Flow Statement 12, the Account Balance Analysis 14 as well as Monthly Interest Rate Outlook Memo (FIG. 20). This strategy provides cash for all expenditures on the exact day needed while recommending length and size of investments for a variety of terms based on conditions specific in the market at that time or writing. Final preparation involves a review of the clients Investment Policy Statement (FIG. 24) in order to ensure no investments are recommended that are not in compliance with said policy. Also, a call to each financial institution that received a letter (FIG. 6) is made in order to verify readiness on part of the financial institutions to work with inventor.

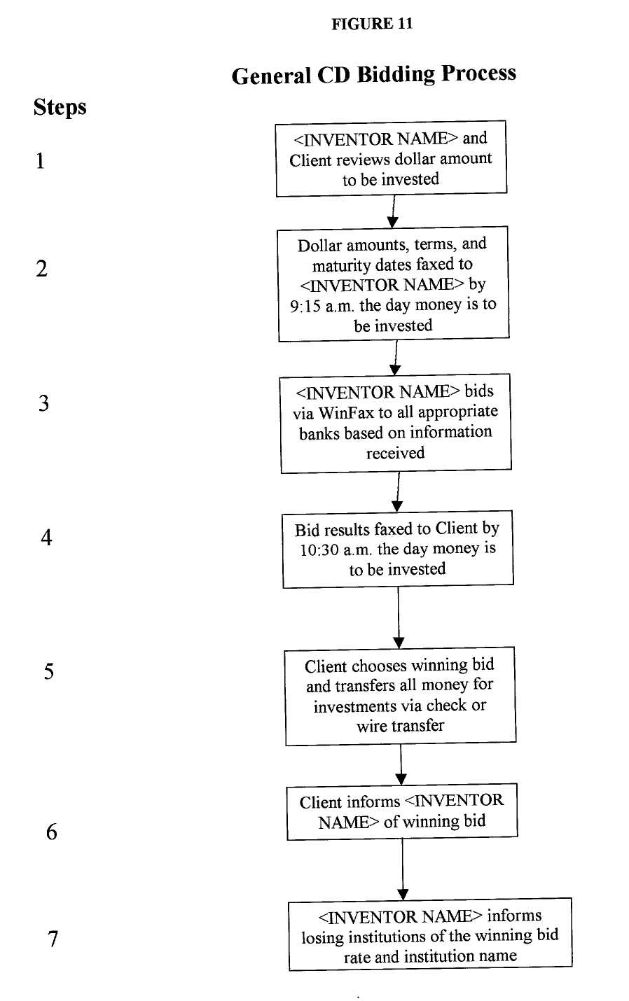

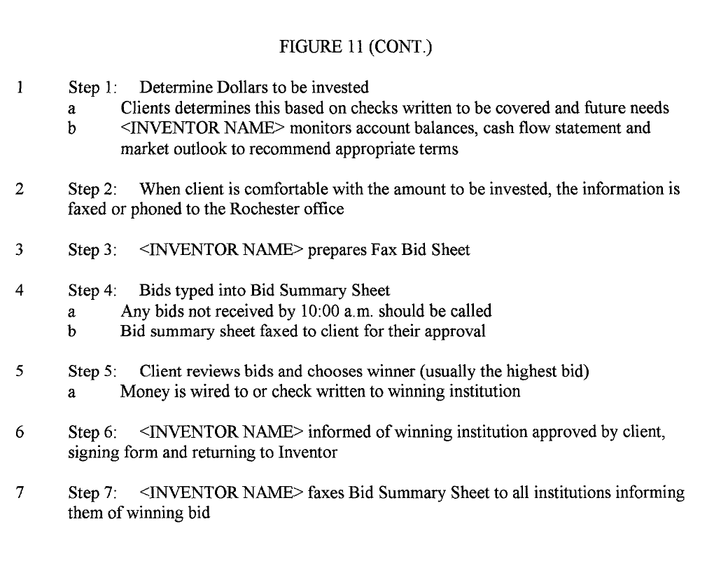

Bidding Process 28 is started by taking the amount determined as shown in FIG. 11 steps 1 & 2 and faxing that information to all approved financial institutions. They respond with a proposed rate with 90 minutes. The data is summarized on FIG. 8 and sent to municipality for approval. Municipality circles the winning bid and returns via fax the circled document. The winning bid is then highlighted and a copy faxed to all financial institutions. All investments are tracked in conventional investment tracking software (not shown) with the ability to produce a variety of reports.

Continuous Monitoring 30 is required in order to know when money is received, when it is needed, and what market conditions have changed that might alter the investment strategy. Account balances are checked and data summarized on Weekly Cash Balance 26 (FIG. 9). As time passes and more data is available, data is graphed and analyzed for potential investment opportunities. A Client Binder 32 is created (w copies) with each section listed under Client Binder 32. This is a reporting mechanism to municipalities as well as a source of information as time elapses. Maturity Schedule (FIG. 18) and Quarterly/Annual Reports (FIG. 19) are printed and provided periodically. A monthly Interest Rate Outlook Memo (FIG. 20) is faxed to municipalities informing them of any adjustments in market conditions. After the 15^{th} of each month, the time at which most finance offices have reconciled books for the prior month, data is requested and used to update Enhanced Cash Flow 12 and Account Balance Analysis 14. The Investment Recommendation Memo (FIG. 13) is updated as needed based on changes in market conditions

Reports 34 are generated periodically (depending on type of report). The conventional investment tracking software (not shown) will generate these reports as per user request. Sample reports are shown in FIGS. 17 to 19. Ratio Report (FIG. 21) is created in a conventional spreadsheet software (not shown) that allows the inventor and municipality to track the percent of all available funds that are invested at any given time.

Health Check 36 is done once each year for a municipality. Legal counsel reviews all legal agreements entered into that deal with finances. This is compared to state laws and the local investment policies adopted. Also, changes in state law are noted. Investments for the year are compared to those allowed to ensure compliance. A summary report of Health Check 36 is provided in a legal letter to appropriate personnel.

Greater detail is provided for each step below.

Preliminary Analysis 10

Using the documents listed in FIG. 5, data is taken and entered into the Enhanced Cash Flow Statement 12 template and the Account Balance Analysis 14 template. This is simple data entry into the standard templates shown in FIGS. 2 & 3 respectively. All items can be found within government-generated reports using their own accounting software. As this software can be (and frequently is) different for each government, the items listed in FIG. 5 are a starting point. It is imperative that all documents generated from the government be on a cash basis as much as possible. A discussion is necessary with the appropriate finance people to ensure cash (and not accrual) is the basis of the reports generated. Most software should be able to produce such a report.

Categories listed in Enhanced Cash Flow Statement 12 (FIG. 2) may change depending on the type of government being serviced (i.e. housing authorities will have different revenue sources than school districts). However, for governments most have similar expenditures (i.e. payroll & benefits, account payables, debt service, etc.). However, unique items that make up a large percent of total revenues or expenditures can be added or changed as needed. Categories should be altered as needed. In using the categories in FIG. 2, a general rule to follow is the 80/20 rule—that 80% of revenues or expenditures are generally accounted for in 20% of the sources. It is good to have only the largest categories and simply place the remainder in an “other” category.

Clients may also dictate the level of detail desired in Enhanced Cash Flow Statement 12.

Creating Enhanced Cash Flow Statement 12

Categories listed in Enhanced Cash Flow Statement 12 (FIG. 2) may change depending on the type of government being serviced (i.e. housing authorities will have different revenue sources than school districts). However, for governments most have similar expenditures (i.e. payroll & benefits, account payables, debt service, etc.). However, unique items that make up a large percent of total revenues or expenditures can be added or changed as needed. Categories should be altered as needed. In using the categories in FIG. 2, a general rule to follow is the 80/20 rule—that 80% of revenues or expenditures are generally accounted for in 20% of the sources. It is good to have only the largest categories and simply place the remainder in an “other” category. However, since this invention deals with investments, it is necessary to keep a separate “Interest Revenue” category (also known as “Use of Money & Property”).

Once the documents have been acquired, summarizing the data into Enhanced Cash Flow Statement 12 (FIG. 2) is mostly data entry work. The categories shown in FIG. 2 are typically found in the documents provided by the government, with some minor differences. Time is needed to peruse the documents to familiarize one with the documents.

The first box to enter is the “Opening Balance.” This number can come from several sources. It may be taken from the Annual Comprehensive Financial Report using the line “Fund Balance” from the end of the last prior year. Also, a total of bank balances from all accounts for that fund plus the outstanding investments can be used. Either should give a good start number. Next, enter the total dollars be major revenue and expenditure source by month. For the notes section, look at the report for payroll and accounts payables to find the payout dates (typically they will fall every two weeks or according to some constant pattern). These are then entered into the “note” boxes with the average amount of the payout.

At the end of the data entry, focus in on the bottom line “End Month Balance.” These numbers start to give a general idea of the available cash for investments. Multiply the monthly End Month Balance by the average yield earned through allowable government investments that matured that same period. (As each state restricts the type of investments that local municipalities may purchase, it is necessary to remain general since the range of investments varies greatly from state to state.) The formula for calculating the expected interest to be earned that month is as follows:

End Month Balance*(average rate earned/360*number of days in that month)=Projected interest earnings

Do this for each month. Next, add up the total projected interest earned and compare that number to the “Interest Earnings” or “Use of Money & Property” line shown in the revenue section of Enhanced Cash Flow Statement 12. This will give an idea of whether the interest earned was near what could have been earned. However, this is not the only test to determine whether this invention can be of service.

The final purpose of the historic creation of Enhanced Cash Flow 12 is to be able to this is to show the historic maximum amount of cash that was available for investments and then use the history to project available cash into the next year.

Account Balance Analysis 14

This step is also simple data entry. After receiving the bank statements from the municipality for the same time period covered by the Enhanced Cash Flow Statement 12, enter numbers from the statements into two of the three columns shown in FIG. 3 (Credits, Debits, Balance). Choosing which not to enter is simply done by looking at each bank statement and determining which of the three categories has the most data to enter (generally this is the debits or credits—however, for savings or money market accounts, the balance column could require the most data entry since the credits and debits are minimal on these type of accounts). After determining which columns to enter, enter the data and create a formula in the column to be calculated. This is a different formula for each column, although the formula will use all the same elements. Enter all data for a 12-month period.

Upon completion of the data entry, graph the balance column across the date column. This should be done according to the spreadsheet software capabilities being used. This graph reveals trends that allow the inventor to tailor an Investment Proposal 24 specific to that account and fund. To determine the potential additional interest to earn required one more piece of information.

Governments, rather than paying directly for banking services, use a compensating balance to pay for their services; that is they leave a certain amount in the account that the banks can use to earn its fees. This amount is different for each account. All banks provide an Account Analysis for each account. Request this document from the government. This document will tell the balance needed to cover the fees associated with the account.

To determine the potential interest that can be earned on the available balance use the following formula each day:

Account Balance at end of day−Compensating Balance Requirement*(average rate earned on investments that month/360)=potential interest to be earned on account balance.

The number calculated is daily. Now, sum the daily numbers over the entire 12 months. This will provide the annual potential increase on those balances in this account.

Repeat this step for each account to be analyzed and sum the total interest per account into one total. This will provide a projection of the total potential increase in interest.

Summary Sheet 16

Using data from Enhanced Cash Flow Statement 12 and Account Balance Analysis 14, insert the appropriate information into the appropriate cells of the summary sheet. (FIG. 4). Also, copy in a copy of one of the graphs from Account Balance Analysis 14 (use the graph that shows the most benefit or summarize the account balances and graph them and insert this graph in to the summary sheet). To determine the percent total increase use the following formula:

Total Potential Increase after Analysis net of projected fees/interest Revenue=% Increase

This sheet is then used to show the municipality the potential interest to be earned through the use of this invention.

Analysis Update 18

This step is very similar to Preliminary Analysis 10 step. However, at times the client will have a contract signed without the inventor providing Preliminary Analysis 10. When this is the case, Preliminary Analysis 10 is part of Analysis Update 18.

This step simply brings to the most current month all data for Enhanced Cash Flow Statement 12 and Account Analysis 14. Request from the government all the documents requested previously through the most current month. Use this data to enter and create a current Enhanced Cash Flow Statement 12 and Account Analysis 14.

In Preliminary Analysis 10, Enhanced Cash Flow Statement 12 and Account Analysis 14 were done only for the General Fund. In this step, the same process needs to be followed for all major funds (i.e. Capital Fund, Water Fund, Sewer Fund, etc . . . ). The only part that is not needed is the creation of Summary Sheet 16.

Documentation 22

There are many documents needed to provide the Muniflow process. All these can be created at the same time, or just after Analysis Update 20 is being done. The following is a list of the documents to be created and how each is done.

1. Letter to Financial Institutions (FIG. 6) This is a standard letter. The only changes that need to be made are those relating to information between the <>. Request this information from the Client and insert in the appropriate parts. This letter can then be provided to the client. The client copies each letter onto its own letterhead, signs and mails the letter. Copies of signed letter are returned to inventor.

a. One possible change to the letter is the 1^{st} paragraph. Governments may not have an account with each bank or brokerage firm. If they do not have an account, then the 1^{st} paragraph may be deleted.

2. Create Fax Bid Sheet (FIG. 7) Again, with the information provided for the Sample Letter to Financial Institutions (FIG. 6), the same information is used to insert into <>. This sheet is never seen by the client other than during the time when the bidding process is discussed with the client. This sheet is faxed to the banks once the appropriate investment data has been entered into the lower section. If more than four (4) investments are to be made, then the sheet can be expanded to a second page to provide more room for more bids. How this sheet fits into the actual bidding process will be discussed in Bidding Process 28 section

3. Create Bid Summary Sheet (FIG. 8) This sheet also uses the same information requested from the client to be inserted into the Letter to Financial Institutions (FIG. 6). Also enter the appropriate information between the <>. The use of this sheet will be discussed in more detail in Bidding Process 28 section.

4. Weekly Cash Balance Sheet (FIG. 9) Again, take the information used to complete the Letter to Financial Institutions (FIG. 6) and insert it into the <>. The use of this sheet will be discussed in more detail under Continuous Monitoring 30

5. Create Minutes sheet (FIG. 10) Minutes of all meetings are kept to ensure a proper record is maintained and to ensure that all parties understood the discussion and results. This is updated after any conversation, whether on the telephone or in person. Enter the appropriate information between the <> and start keeping notes since the date of the signed contract (sooner if desired).

6. Tailor Bidding Flow Chart (FIG. 11) to the Client. Simply replace the word Client everywhere shown with the Client's name. This document is used to review with the client the actual bidding process. The entire process will be reviewed in more detail under the Bidding Process 28.

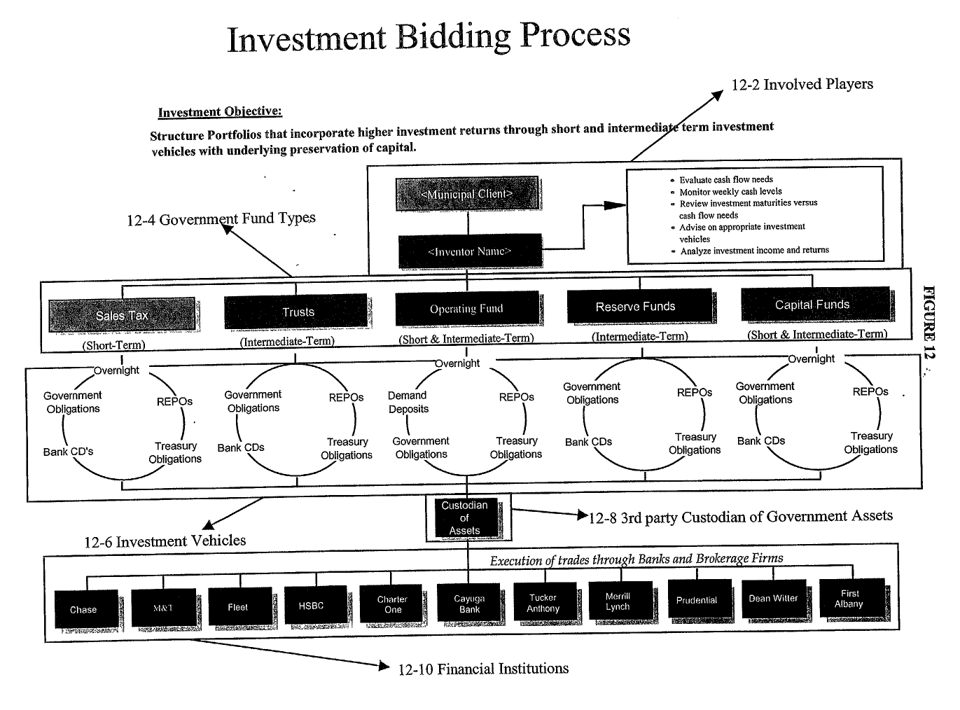

7. FIG. 12 is a graphical representation of how the Inventor works with the client, the financial institutions and the different funds to determine the term of the investment and the interaction of all parties. No updates need to be made to this drawing.

Investment Preparation 22

In gearing up for actual investments, several steps must be taken before the process works efficiently. First, a list of all current investments with the following information must be obtained from the client:

1. Type of Investment (i.e. CD, Treasury Note, Corporate Paper, etc.)

2. Date investment was purchased

3. Date of Maturity

4. Yield

5. Fund to which the money and interest earning belongs.

6. Quantity or amount of the investment

7. Actual Cost (principal plus any accrued, if any)

8. CUSIP # (unique identifying number provided by bank or original generator of bond) when applicable

9. Where the investment is held (bank or brokerage firm)

This data is then entered into the conventional investment tracking software (not shown).

A follow up call is made to each of the financial institutions with whom the client currently works (every one who received a Letter to Financial Institution (FIG. 6). Simply explain to them that each week (choose any day and stay with that day), a representative will call and request the “available cash balance” for each of the accounts at that bank. Also, describe the general bidding process, which is:

Fax Bid Sheet (FIG. 7) will be faxed around 9:00 a.m.

Results are required within one hour

Each financial Institution will receive a Bid Summary Sheet approximately one hour after the bids are closed showing who won the bid, the winning rate, and the bids of all other financial institutions.

Get a fax number from the financial institution where all information regarding the bidding process can sent.

The next step is to write Investment Proposal 24 (FIG. 13) specific to client cash needs as determined by Preliminary Analysis 10 and Analysis Update 18. Creating this requires the use of all information gathered from Preliminary Analysis 10 and Analysis Update 20. Additional information about the market can be gathered from a variety of financial sources (CNBC, Wall Street Journal, etc . . . ). Also, due to the large amount of bidding being done for all clients, the inventor has a good idea of current rates and best terms in the current market. Other market research is performed in order to understand what the future may hold. Questions to consider are:

1. Is inflation in check?

2. When the Federal Reserve meets again will rates be increased, decreased or kept the same?

3. Will the Federal Reserve change its bias toward future rate changes?

4. What other economic indicators (Housing starts, unemployment data, etc) may be insightful for changes in rates?

This research helps determine whether Investment Proposal 24 (FIG. 13) will be designed around extending maturities as much as possible or keeping all investments short.

This Investment Proposal 24 is updated as the market and cash flow needs indicate, but generally about every 6 months. Changes may be slight or drastic depending on how the market has changed. The market is typically more volatile than a municipality's cash flow, which is fairly certain year after year.

The final step of Investment Preparation 22 is to review the clients Investment Policy Statement (FIG. 24). General Municipal Law of each state may require each municipality to have an adopted Investment Policy Statement (IPS). If the state does require this, than guidelines of what is to be included are also generally given as part of the law. If an IPS does not exist, write one for them by following state law or using FIG. 24 as a template. The purposes of this statement is to:

1. Discuss Safety of Public Funds

2. Discuss Liquidity for operational use

3. Discuss Accountability

4. Provide a form of measurement to gauge success of the investment program.

The review of this statement will allow the inventor to insure that appropriate investment vehicles are used as outlined in the IPS, all requirements are met as detailed, and that all parties understand the appropriate roles.

Bidding Process 28

The bidding process segment ensures that accountability stays with the government for investing, but that the work in finding the best investments is done by the inventor on a larger scale for many municipalities. The general process is outlined in FIG. 11. The specific steps are detailed here.

1. Discuss the investments to be done with the client. The client will know of the immediate cash needs. The inventor will have the analytical tools of cash needs and the market outlook to help gauge the timing of the investments. Once the final numbers and dates have been agreed upon, the inventor provides the bidding process

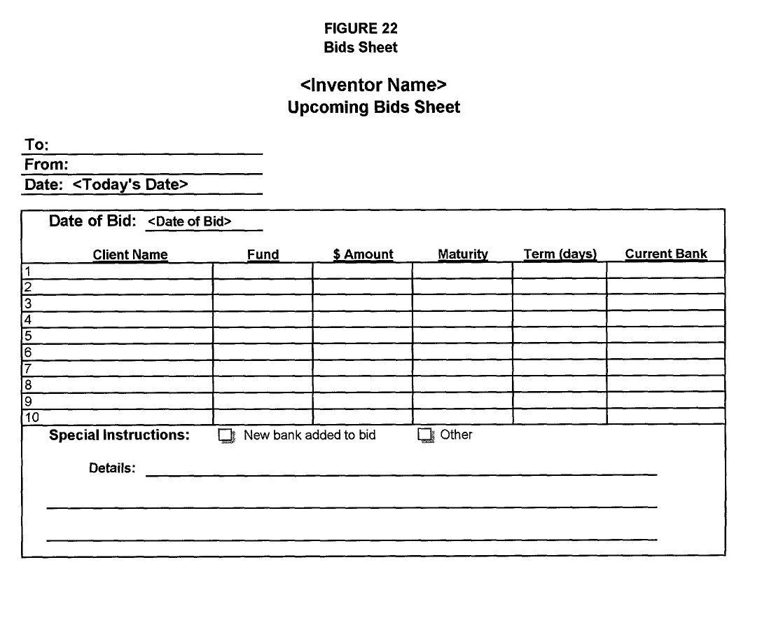

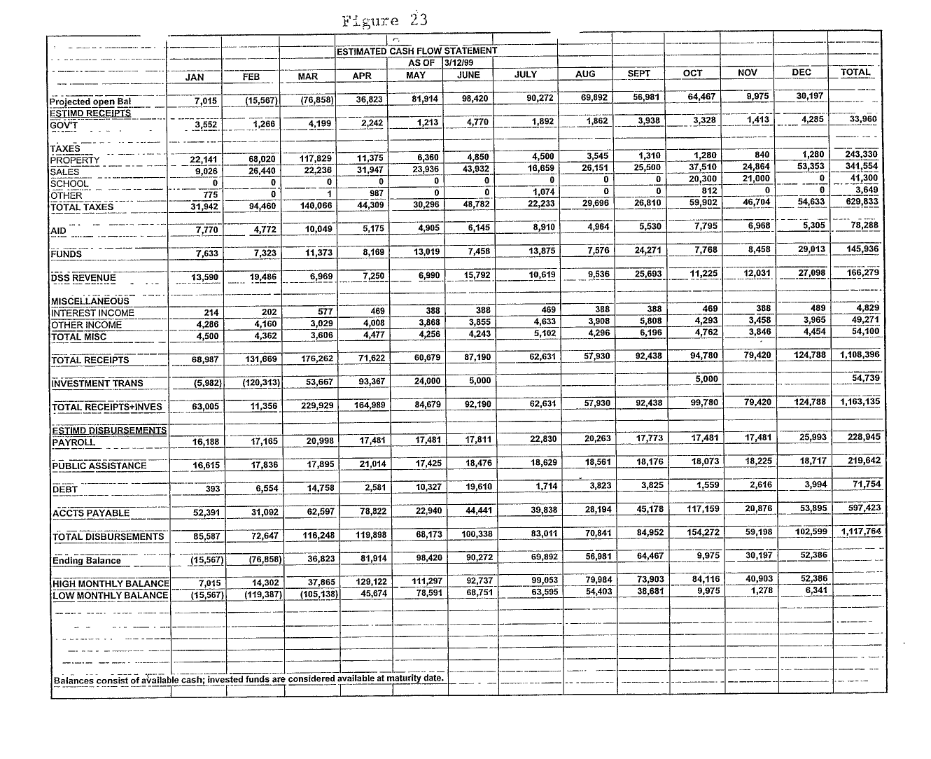

2. Compile the days bids—these are found on sheets similar to the one seen in FIG. 22. Most will be on sheets either faxed from employees or called in and placed on this sheet by the employee assigned to bid (see the sample below—all the information you need is on this sheet)

[image]

[image]

[image]

[image]

[image]

[image]

[image]

40. Go to the “G:/Winword/Users/<Inventor Name>/Bid/FAX” folder and choose the PRN file that you previously saved in Excel—it should be the client name.

41. Now click the button “Submit Broadcast” and the summary sheets are sent

42. At this point you are done with the bidding process. Be sure to leave all three copies of the Excel “Bid Summary Sheet” along with the signed sheet from the client. These will be filed appropriately.

43. Record the day's investments into the investment tracking software being used.

Continuous Monitoring 30

Maximizing interest earned on available cash takes a continuous monitoring approach. Although it is typically known when taxes and other receipts are due, actual receipts may fluctuate by several days (i.e. the state may not forward sales tax money or state aid funds on the projected date, but rather 1 or 2 days later or earlier.). In order to invest this money on the first day available, monitoring bank accounts balances and other steps are needed.

Checking account balances does not have to be done daily. However during property tax collection season or other high volume receipt periods, it should be done daily. All other periods are done weekly, on the same day in order to track any patterns associated with the accounts (FIG. 16). Checking these accounts is simple—as follows:

1. Call all banks with whom the client has accounts (the ones that received a Letter to Financial Institutions—FIG. 6)

2. Request from the appropriate person the “Available Balance” for the accounts—provide the account numbers. If questions arise, simply explain the authority has been given and refer them to the letter and the person at the bank who received the letter.

3. Record these amount on the appropriate sheet (FIG. 9).

4. Also record the balances into the spreadsheet in order to graph and find patterns (FIG. 16)

As time passes, review each account's historic balances to see if there are patterns that can be used to invest. Payroll and Account Payable accounts have typical patterns across all types of municipalities. This historic data will be used in the 6-month (or whenever) revision of the Investment Recommendation Memo 24.

The next step of Continuous Monitoring 30 is to create a client binder that is used to track all work done with the client. Parts of the binder are:

1. Client Investment Policy Statement (FIG. 24)

2. Investment Advisor Agreement

3. Minutes (see FIG. 10)

4. Weekly Cash Balances (FIG. 9)

5. Bid Results (FIG. 8)

6. Current Portfolio (FIG. 17)

7. Maturity Schedule/Quarterly & Annual Reports (see FIGS. 18 & 19 respectively)

8. Monthly Interest Rate Outlook Memo (see FIG. 20) and any other correspondence from inventor to client

9. Other company publications

There are two copies of this binder—one for the client and an identical one for the inventor. Materials are mailed or delivered to the client at least once each month and more frequently as needed.

Part of Continuous Monitoring 30 includes updating, at least monthly, the Interest Rate Outlook Memo (FIG. 20). This memo is generally a monthly description of the current market and what the inventor believes the future to look like. It also provides general recommendations on how investments should be laddered. The memo is followed up with each individual client to apply the recommendations specifically to the client's cash flow.

After the 15^{th} of each month (15^{th} is used since it generally takes the municipalities that long to close out the books of the prior month), request from the client all documents needed to update Enhanced Cash Flow 12 and Account Balance Analysis 14. This is to help determine whether there have been significant changes to the cash flow that will alter the investment strategy significantly. Also, this allows progress to be gauged monthly on the interest being earned.

Near the end of the client fiscal year, the current Enhanced Cash Flow 12 can be used to provide the client with a projection for the upcoming fiscal year. The projection of the next fiscal year to adjust for known changes, such as:

1. New debt payments from current year borrowing.

2. Known salary adjustments due to annual raises

3. Changes in the tax levies

4. Other known changes that impact the cash flow

This projection is then used to look at the next fiscal year investment strategy.

Continuous Monitoring 30 also includes updating the Investment Recommendation Memo 26. Changes may be slight or large depending on the investment market outlook and the client's cash flow.

Reports 32

Accountability when dealing with public funds is important to municipalities. Monthly, quarterly and annual reports are provided.

FIG. 17 is a Current Portfolio Report. The software used to track client investments is able to create this report as of any date desired. These reports are typically issues as of the last business day of the month. Also from this report, the monthly fee associated with the Muniflow services is determined.

Quarterly and Annual Reports (FIG. 19) are provided as appropriate. The data is simple and only needs to be entered or altered each quarter. Data is taken from the investment tracking software being used and from the client's own financial statements that detail the interest actually earned year to date.

Other reports are helpful in gauging whether cash is being maximized in the investment process. The Ratio Report (FIG. 21) is one of these. This shows the total dollar value invested as a ratio of the total dollars available for investments. The difficult part is finding the delineation between what is “invested” and what is not. Simple interest earnings on a savings account do not generally qualify as an investment, although the funds are earning interest. However, some money market funds provide sufficient yield to qualify. A line should be determined and then held constant across all reports. In this case, money market yields within 75 basis points (or ¾ of 1%) of the allowable investment vehicles (i.e. CDs, commercial paper, etc.) are considered investments. Others are not. To create the report, follow the columns as shown in FIG. 21

1. Add all “available cash” in the bank accounts that do not qualify as an investment account, as of the last day of the month, and place in the appropriate column.

2. Add all investments, which include money market and other accounts that qualify, and insert into the appropriate column.

3. Add these together to find total cash or “Assets.”

4. Set up the formula in the spreadsheet to show two ratios (together the two ratios will total 100%)

a. Account Balance/Total Assets=Ratio Balance to Total

b. Total Investment/Total Assets=Ratio Investments to Total

5. Provide an average in the final row of the table

This report is designed to show progress in the investments of funds. The goal is to increase the “Investment to Total” ratio to be as close to 100% as possible. However, 100% is not the goal, as cash will always be needed in operating bank accounts for governmental purposes. Also, since governments may not typically pay direct fees for banking services; the appropriate compensating balance needs to be left in the accounts in order for the banks to receive the appropriate fee to pay for services provided. The goal is to increase the ratio so that only the compensating balance levels are met and the remainder is left in investment accounts or vehicles until the day transferred for use.

A Monthly Interest Rate Outlook Memo (FIG. 20) is sent to update municipalities as to the status of the market. This is sent monthly, but could be more frequently as market conditions change. General investment recommendations are provided as per the market conditions discussed.

The next Reports 32 step is to meet at least monthly with the client to discuss issues, progress, investments and other topics. This ensures that all parties continue to understand the roles of each. However, clients may request more frequent or infrequent visits.

On an annual basis, the Inventors legal counsel provides an annual Health Check 36. This simply is reviewing all legal documents to ensure compliance by all parties have been met. Also, the state regulations guiding investments may have been changed. The inventor through this Annual Health Check 34 notifies the client of how this should be represented in the Investment Policy Statement and other documents. Any concerns or issues are provided to the client in memo format.

### Conclusions, Ramifications, and Scope

Accordingly, it can be seen that my invention provides a way to monitor at all times avialable cash, determine through historic analysis the amount of cash available for investments, the timing of that investment and the market expertise needed to determine the best possible investment vehicles. All this leads to maximize the amount of dollars invested thereby increasing interest earnings of a municipality.

Further, it can be seen that my invention provides for a better cash flow projection, better understanding of market conditions, assists in determining the best timing and term of borrowing, potential to enhance credit rating by showing due diligence to those organizations who provide bond ratings to municipalities, finding better banking services and products that also maximize cash flow, more efficient internal office processes and ease of audits due to provided reports and filing system.

Although the description above contains many specificities, these should not be construed as limiting the scope of the invention but as merely providing illustrations of some of the presently preferred embodiments of this invention. Various other embodiments and ramifications are possible within it's scope. For example, although this has been applied to municipalities, any organiztion, private, public, not-for-profit, or any else could also benefit from the Muniflow process. Cash flow and investments is inherent to any organiztion that recieves and expends money as well as holds that money during the time it is recieved and the time it is expended.

Ramifications

Thus the scope of the invention should be determined by the appended claims and a their legal equivalents, rather than by the examples given.

What is claimed is:

1. A means by which invested dollars are increased substantially by:
a historic analysis as a means to determine historic available dollars for investment,
constant monitoring of funds to provide current information on what is actually available,
a projection of future market conditions,
where said projection is combined with said historic analysis to create an investment strategy,
where the said investment strategy is used as a guide to provide competition between financial institutions
document are used as a means to provide information to all parties involved
whereby more money is invested than had previous been and interest earnings are created on the most dollars available.

2. The historic analysis in claim one means to better project future cash flows and cash levels means to better information to base decisions of debt financing.

3. The historic analysis in claim one means to provide opportunity to enhance credit rating for debt financing.

4. The historic analysis in claim one means to alter banking services to better match cash flow needs.

5. The documents in claim one means for simplet audit through consistent method of filing appropriate documentation.
